(19) United States
(12) Patent Application Publication
(10) Pub. No.: US 2003/0105839 A1
(43) Pub. Date: Jun. 5, 2003

(54) Method and system for provisioning broadband access and automated configuration of broadband devices

(76) Inventor: Jeffrey P. Ben, Santa Clara, CA (US)

Correspondence Address: HEWLETT-PACKARD COMPANY, Intellectual Property Administration, P.O. Box 272400, Fort Collins, CO, 80527-2400, US

(21) Appl. No.: 10/011,046

(22) Filed: Dec. 4, 2001

(51) Int. Cl. G06F 15/177

(52) U.S. Cl. 709/220

(57) ABSTRACT

A method for provisioning broadband access service and automatically configuring a broadband communication device is disclosed. An embodiment provides for a method in which a server may be contacted when broadband access service and device configuration parameters are needed. This contact may be initiated via a dial-up modem. Next, the server determines broadband service providers for the user. This may be done by using caller-ID to identify the geographic region for the customer. A list of such providers is transferred to the user. From this list, the user selects a service provider. Next, the server determines configuration parameters for the broadband communication device. For example, the server may link to the selected Internet service provider to obtain the proper configuration parameters for this user. Then, the configuration parameters are transferred over the dial-up communication link to the user. Finally, the broadband communication device is automatically configured with the configuration parameters.

### TECHNICAL FIELD

The present invention relates to the field of broadband Internet access. Specifically, the present invention relates to a method for providing Internet service for consumers without an existing broadband connection and automatically configuring a broadband communication device.

### BACKGROUND ART

Many households currently have a dial-up or narrowband Internet access service. Today, more broadband Internet access options are surfacing. Furthermore, a growing number of households with dial-up service have two or more personal computers (PCs). The growth in multi-PC households and broadband Internet access services make it desirable to allow the sharing of broadband Internet access among multiple PCs.

One inhibitor to such sharing is the complications involved in obtaining the broadband access service itself. For example, it may be difficult and confusing to determine what services are available in the user's area, the terms of service, and pricing. Consequently, it may be difficult for a consumer to make an informed decision regarding what broadband service provider to choose.

A second inhibitor to sharing a broadband connection is performing the necessary configuration of the customer premises network equipment (CPNE) after the broadband access has been established. The CPNE such as broadband modems, routers, and modem-router combination products require being setup with connection specific information. This information may comprise an IP address, user authentication information, a communication type, a channel type, etc. This information (e.g., communication parameters) may be quite complex, requiring the user to have substantial computer knowledge to correctly configure the CPNE. While a savvy computer user may be able to correctly configure the CPNE, many users will have trouble, leading to customer dissatisfaction and increased customer support costs.

Furthermore, the type of setup information is specific to each Internet access service provider because each may use differing schemes for allocating network addresses, authenticating subscribers, and providing access to client services such as news, e-mail, and voice. Further complicating the configuration process is the fact that different providers may assign different names to a given configuration parameter. Even the same provider may assign different names to the same parameter. Thus, the problem of a user selecting a service provider is intertwined with the problem of configuring the CPNE.

Consequently, it is difficult to develop a simple set of instructions to walk the user through configuring the CPNE. For example, a set of instructions may ask the user a series of if-then questions, with the user's answers determining what questions will be asked next. Clearly, if the user responds incorrectly, the wrong branch of follow up questions is asked and the process is likely to fail.

One conventional attempt to solve these problems is to require the user to visit a web site of the CPNE vendor or to call the vendor. The user is provided with a code which is unique to the customer's broadband service provider. This code is then used during the CPNE setup process to reduce the number of setup fields and choices to the ones that are relevant for the specific provider. However, the customer still faces the problem of difficult nomenclature, as well as the possibility of making mistakes leading to a failed installation.

Accordingly, the present invention provides a method and system for provisioning broadband access and automatically configuring a broadband communication device, such as a broadband modem, router, or modem-router combination. The present invention does not require the user to manually enter configuration parameters. These and other advantages of the present invention will become apparent within discussions of the present invention herein.

### DISCLOSURE OF THE INVENTION

A method for provisioning broadband access service and automatically configuring a broadband communication device is disclosed. An embodiment provides for a method in which a server may be contacted when broadband access service and device configuration parameters are needed. This contact may be initiated via a dial-up modem. Next, the server determines a list of broadband service providers for the user. This may be done by using caller-ID to identify the geographic region for the customer. A list of such providers is transferred to the user. From this list, the user selects a service provider. Next, the server determines configuration parameters for the broadband communication device. For example, the server may link to the selected Internet service provider to obtain the proper configuration parameters for this user. Then, the configuration parameters are transferred over the dial-up communication link to the user. Finally, the broadband communication device is automatically configured with the configuration parameters.

Another embodiment provides for a system for provisioning broadband service and automatically configuring a broadband communication device. The system comprises a server and a node to which the broadband communication device is connected to configure it. The node may be at the point-of-purchase of the broadband communication device. At the node, a user is prompted to enter information to initiate the provisioning of broadband service and configuring the device. The node provides the user with a list of service providers in the user's geographic region. The server is able to determine the device configuration parameters based on the user selected service provider. Finally, the server is able to transfer the configuration parameters to the node, wherein the configuration parameters are available to configure the broadband communication device.

Another embodiment provides for a method of configuring the communication device at the point of purchase. A node issues a prompt for user information to be entered. This information (e.g., the user's telephone number) allows the determination of a list of broadband service providers in the user's geographic region. This list of broadband service providers is displayed at the node. Then, the user inputs a selection of a broadband service provider at the node. Based on the selected broadband service provider, the broadband communication device configuration parameters are determined. These parameters are then used to automatically configure the broadband communication device at the node.

In the above embodiment, the node may contact a server to determine the broadband service providers in the user's area and/or the device configuration parameters.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a diagram illustrating the flow of information in provisioning broadband service and automatically configuring a broadband communication device, according to embodiments of the present invention.

FIG. 2A, FIG. 2B, and FIG. 2C are diagrams illustrating systems for provisioning broadband service and automatically configuring a broadband communication device, according to embodiments of the present invention.

FIG. 3 is a flowchart illustrating steps of a process of provisioning broadband service and automatically configuring a broadband communication device, according to embodiments of the present invention.

FIG. 4 is a flowchart illustrating steps of a process of provisioning broadband service, according to embodiments of the present invention.

FIG. 5 is a diagram of a system for provisioning broadband service and automatically configuring a broadband communication device at a point of purchase, according to embodiments of the present invention.

FIG. 6 is a flowchart illustrating steps of a process of provisioning broadband service and automatically configuring a broadband communication device at a point of purchase, according to embodiments of the present invention.

### BEST MODE FOR CARRYING OUT THE INVENTION

In the following detailed description of the present invention, numerous specific details are set forth in order to provide a thorough understanding of the present invention. However, it will be obvious to one skilled in the art that the present invention may be practiced without these specific details or by using alternate elements or methods. In other instances well known methods, procedures, components, and circuits have not been described in detail as not to unnecessarily obscure aspects of the present invention.

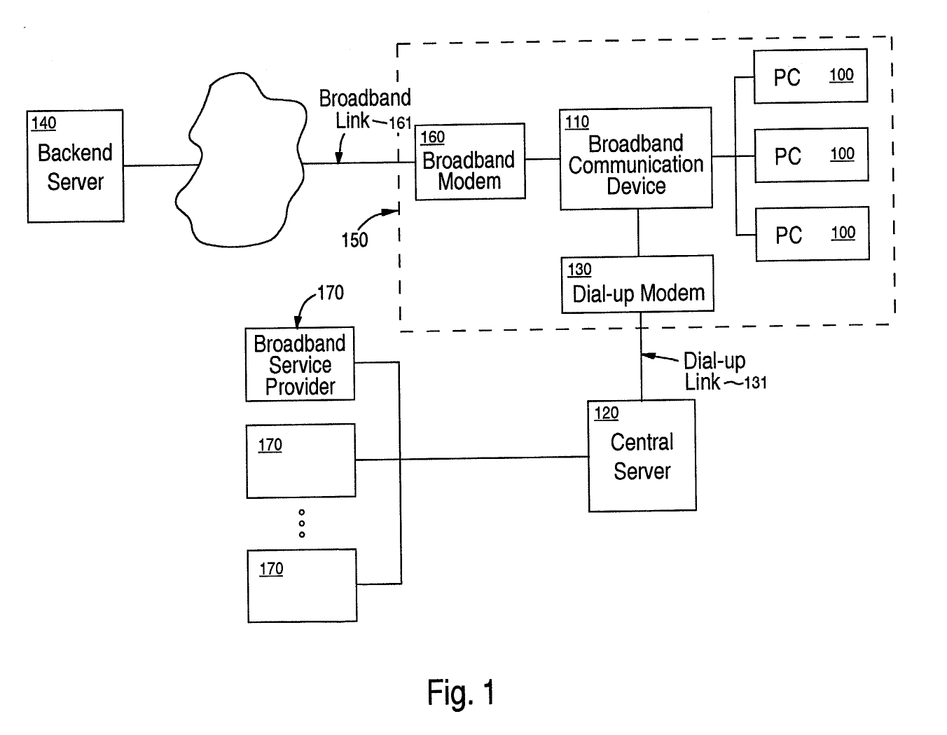

One embodiment of the present invention allows a user who has purchased a broadband communication device, such as, for example, a broadband modem, router-modem, router, gateway, or the like to obtain broadband access and to automatically configure the broadband communication device. Referring to FIG. 1, a user without broadband access may establish a valid broadband link 161 to enable it to communicate with backend server 140, the Internet, etc. The user also may use the broadband communication device 110 to share the broadband link 161 with multiple PCs 100.

FIG. 1 shows a remote node 150 with a broadband communication device 110 connected to a dial-up modem 130, a broadband modem 160, and personal computers (PCs) 100. The broadband communication device 110 may be a device such as, for example, a router or a router-modem combination. The broadband communication device 110 may also be known as a gateway device, which may function to allow multiple electronic devices (e.g., personal computers 100) to share a communication link (e.g., broadband link 161). Throughout this application, the term broadband communication device 110 may mean a device operable to communicate over a broadband communication link 161, such as, a broadband modem, a router, a router-modem combination, a gateway device, or the like. While shown in FIG. 1 as a separate unit, the broadband communication device 110 may include the dial-up modem 130 and/or the broadband modem 160. In order to establish a connection to the back-end server 140, the broadband communication device 110 may need to be configured with various parameters. Furthermore, in order to share the broadband communication link 161 among multiple PCs 100, the broadband communication device 110 may need to be configured with parameters related to the broadband communication link 161 and/or broadband service provider 170.

To establish broadband service (e.g., provisioning) the user may connect to a central server 120 via a dial-up modem 130. For example, the user may open a web-browser on PC 100 to facilitate this step, although this is not required. The user may be provided with software to load on PC 100 that has stored a contact with the central server 120, such as, for example, a telephone number or web site URI (Uniform Resource Indicator).

The central server 120 may then determine who the customer is through an identification of the source of the communication. For example, the central server 120 may use a caller-identification as is provided in a conventional telephone call (e.g., caller-ID). However, the present invention is not limited to this technique. Furthermore, a broadband communication device 110 serial number may be provided to the central server 120. More generally, the dial-up modem 130 may be any device which provides a communication link to the central server 120.

The central server 120 may transfer a list of broadband and/or narrowband service providers to the remote node 150, which may display them on a PC 100. The user may then select a broadband service provider 170 and transfer the selection to the central server 120 via the dial-up link 131.

The central server 120 has links to a number of broadband service providers 170. Using these links, the central server 120 is able to broker broadband and/or narrowband communication access and to determine appropriate configuration parameters for the broadband communication device 110.

The central server 120 then transfers the configuration parameters over the dial-up communication link 131. Once the configuration parameters are at the broadband communication device 110, the broadband communication device 110 may use the parameters to configure itself. However, it is not required that the broadband communication device 110 configure itself. For example, the PC 100 may be used to configure the broadband communication device 110.

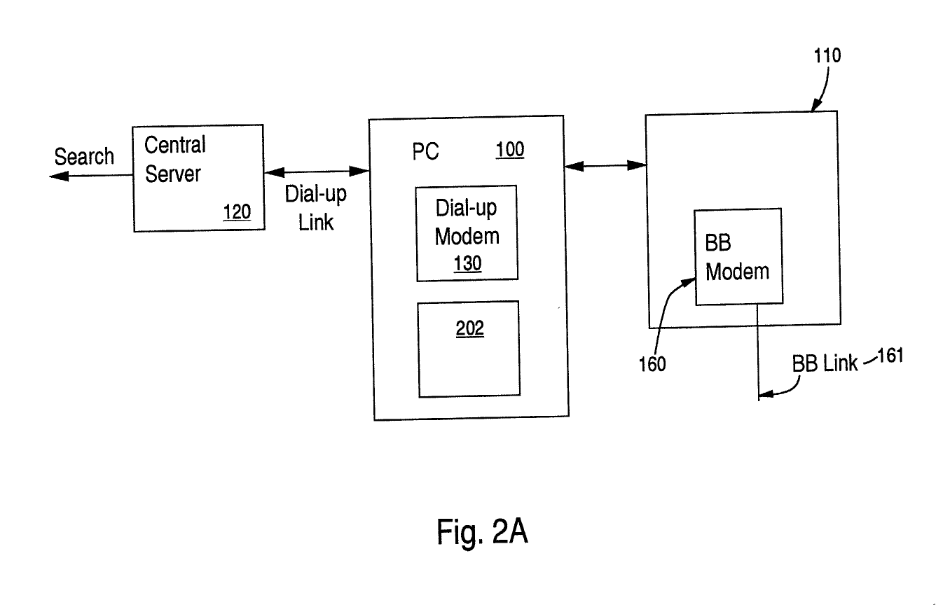

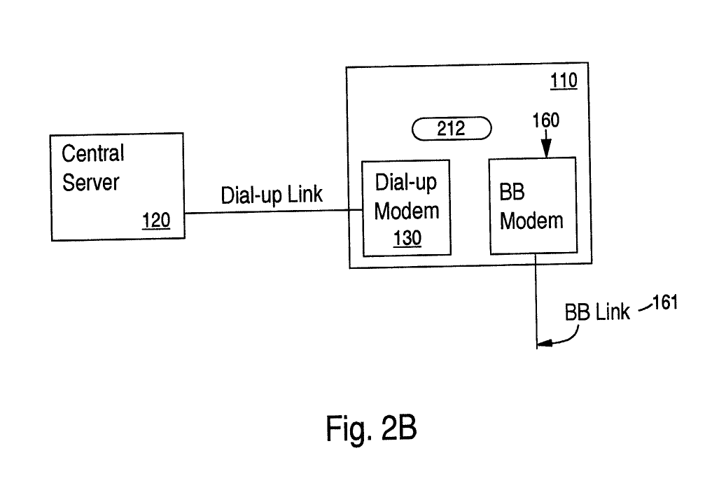

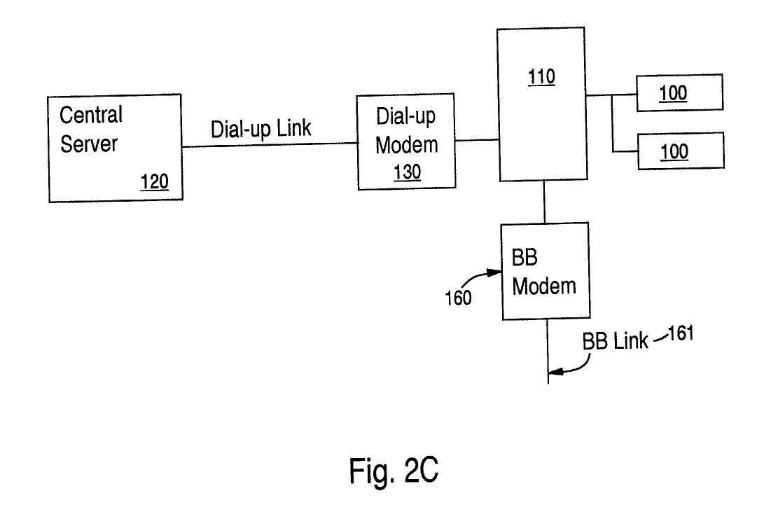

The remote node 150 may have numerous variations of its hardware configuration. FIGS. 2A shows an embodiment in which the broadband communication device 110 contains a broadband modem 160 and the PC 100 contains the dial-up modem 130. For example, the broadband communication device 110 may be a modem-router combination, although this is not required. It may be stated that the broadband communication device 110 is a broadband modem 160, in this embodiment. In an embodiment of FIG. 2A, there may be software 202 or other logic on the PC 100 to assist in the configuration of the broadband communication device 110 and/or the broadband modem 160. There may also be software on the PC 100 to assist in contacting the central server 120 and in displaying and entering information involved in provisioning broadband access. This software 202 may have been provided to the user when the broadband communication device 110 was purchased. Thus, in this embodiment, it is the PC 100 which uses the dial-up modem 130 to contact the central server 120 and configures the broadband communication device 110 and/or the broadband modem 160. Alternatively, the dial-up modem 130 may be external to the PC 100, but controlled by the PC 100.

FIG. 2B shows an embodiment in which the broadband communication device 110 contains both a broadband modem 160 and a dial-up modem 130. The broadband communication device 110 may comprise logic 212 for performing the configuration.

FIG. 2C shows an embodiment in which the broadband communication device 110 (e.g., a gateway device) is connected to an external broadband modem 160 and a dial-up modem 130. In this embodiment, the gateway 110 may configure itself 110 and/or the broadband modem 160 with the returned configuration parameters. It will be understood that other hardware configurations may be used in various embodiments of the present invention.

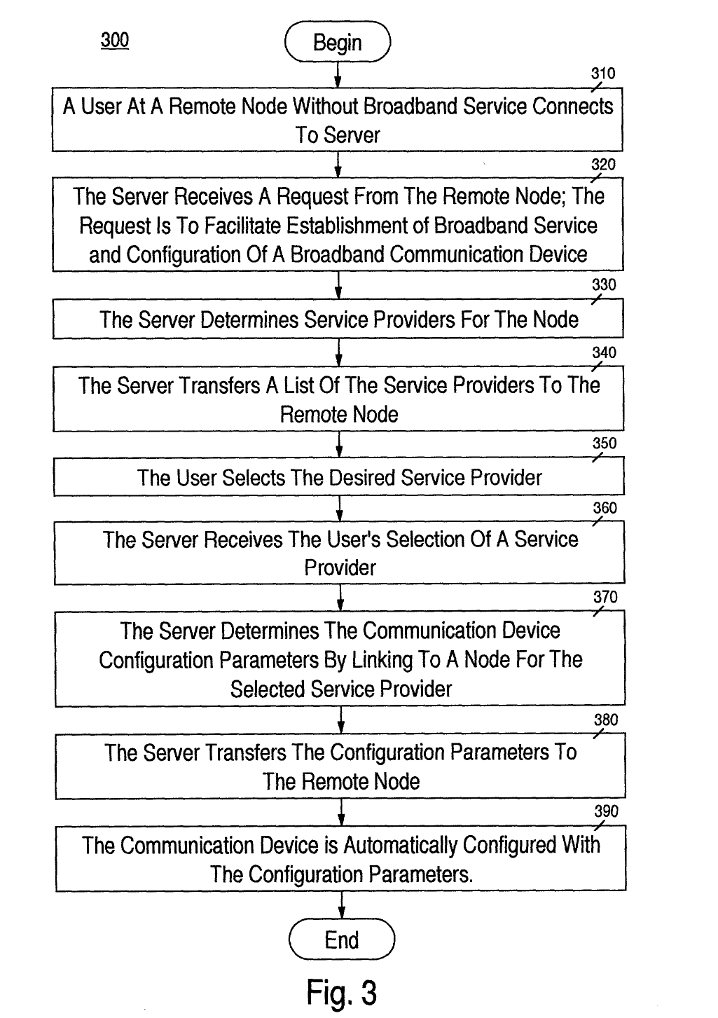

An embodiment of the present invention provides for a method of provisioning broadband access and automatically configuring a broadband communication device 110 and is illustrated in steps of process 300 in FIG. 3. In step 310, a user at a remote node (e.g., remote node 150) without broadband access connects to central server 120. This may be a user with narrowband (e.g., dial-up) Internet access who connects to central server 120 by opening a web-browser on PC 100. For example, when purchasing the broadband communication device 110, the user may receive software to load onto PC 100, which enables the web-browser to automatically connect to the central server 120. For example, the software has a URI (Uniform Resource Indicator) to reach the central server 120 via a dial-up Internet connection. Alternatively, the software has a telephone number (e.g., a 1-800 telephone number or the like) to contact the central server 120.

In step 320, the central server 120 receives a request from the remote node 150. The request indicates to the central server 120 that the remote node 150 desires to establish broadband access (e.g., desires a broadband connection link 161) and may also request that the broadband communication device 110 be automatically configured.

In step 330, the central server 120 determines which broadband (and possibly dial-up) service providers 170 are available in the user's geographic region. For example, the central server 120 may use a caller-ID to identify the geographic region of remote node 150. Alternatively, the user may enter information into a program running on the PC 100. For example, the user may enter the user's phone number or other information which allows the central server 120 to determine which broadband service providers 170 serve the user's region.

In step 340, the central server 120 transfers a list of broadband service providers 170 to the remote node 150. Dial-up access providers may also be provided. This list may be transferred via the dial-up link 131 or the like. For example, the list may be sent to the dial-up modem 130 and transferred to the PC 100, where it is displayed by a browser program or the like. The list may provide pricing information, terms, etc.

In step 350, the user at the remote node 150 selects a broadband service provider 170. The user may also select a narrowband or dial-up service provider.

In step 360, the central server 120 receives the user selection. The central server 120 may log this selection or selections and send back a confirmation to the remote node 150.

In step 370, central server 120 brokers a broadband communication link 161 between the selected broadband service provider 170 and the remote node 150 by linking to a node for the selected broadband service provider 170. The central server 120 may send to the selected broadband service provider 170 subscriber information to establish a new account. Additionally, the central server 120 may prompt the user for additional information that cannot be automatically determined from the user's telephone number.

In step 380, the central server 120 determines the communication device parameters. This may be accomplished by receiving parameters from the selected broadband service provider 170. For example, the broadband service provider 170 may send subscriber configuration parameters such as static or dynamic IP, DNS, a default username and password, PPPoE or not, etc.

Alternatively, the central server 120 may access, possibly after a delay, a database 150 for the broadband service provider 170, in which customer information is stored. In this embodiment, the central server 120 scans databases 150 for configuration information (e.g., parameters). The scan may use a telephone number, customer name, or any other suitable data from the caller-ID.

In step 390, the central server 120 transfers the configuration parameters to the remote node 150 via the dial-up communication link 131.

Then, in step 395, the configuration parameters are used to configure the broadband communication device 110. The process 300 then ends.

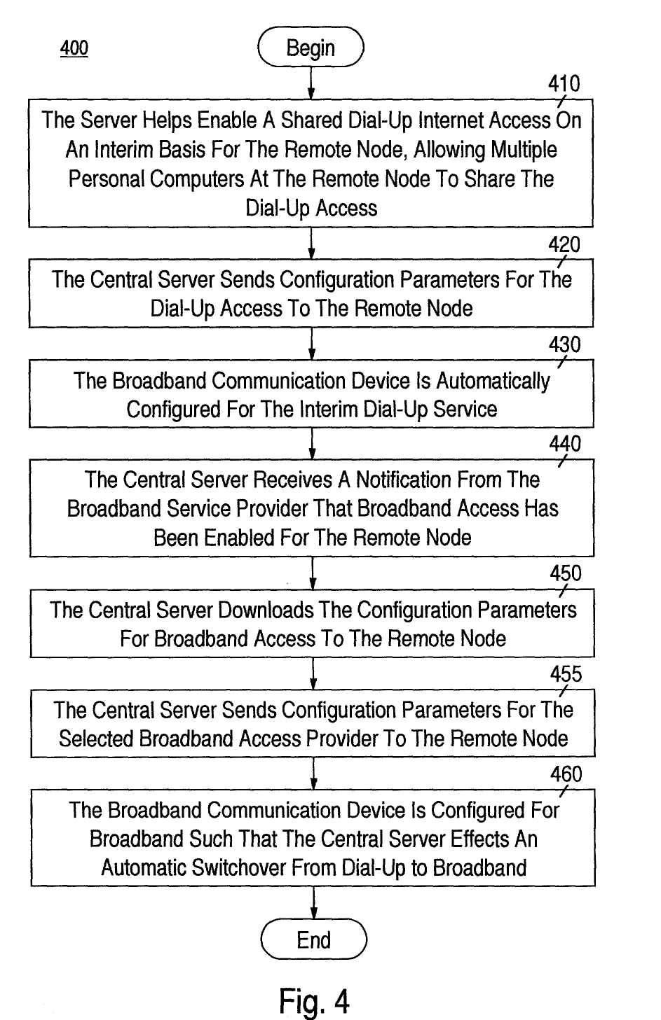

FIG. 4 illustrates steps of a process 400 for enabling temporary dial-up access and switching over to broadband access when it is activated. In step 410, the central server 120 helps to enable dial-up access on an interim basis. This may be provided by a user selected dial-up provider or, alternatively, the central server 120 itself. In one embodiment, if the broadband service requires a truck roll (e.g., a visit to the remote node 150 to enable service), the broadband communication device 110 may be temporarily configured for dial-up access.

In step 420, the central server 120 sends configuration parameters for the dial-up access to the remote node 150.

In step 430, the broadband communication device 110 is automatically configured for the interim dial-up service. In this fashion, the multiple PCs 100 coupled to the broadband communication device 110 (e.g., gateway device) may share the dial-up access.

In step 440, the central server 120 receives a notification from the broadband service provider 170 or otherwise that the broadband access has been enabled for the remote node 150.

In step 450, the central server 120 downloads the configuration parameters for broadband access to the remote node 150. In many cases, the broadband service provider 170 may be able to provide these parameters. However, in case it does not, the central server 120 may be able to scan a database associated with the broadband service provider 170 to determined the configuration parameters. In some cases, the central server 120 may be able to broker broadband service, but not be able to provide all the configuration parameters. In this event, the central server 120 may walk the user through a set-up process to configure the broadband communication device 120 after providing broadband service, if desired.

In step 455, the central server 120 transfers the configuration parameters for the user selected broadband access provider to the remote node 150 via the dial-up link 131.

Then, in step 460, the broadband communication device 110 is configured for broadband such that the central server 120 effects an automatic switchover from dial-up service to broadband service. The process 400 then ends.

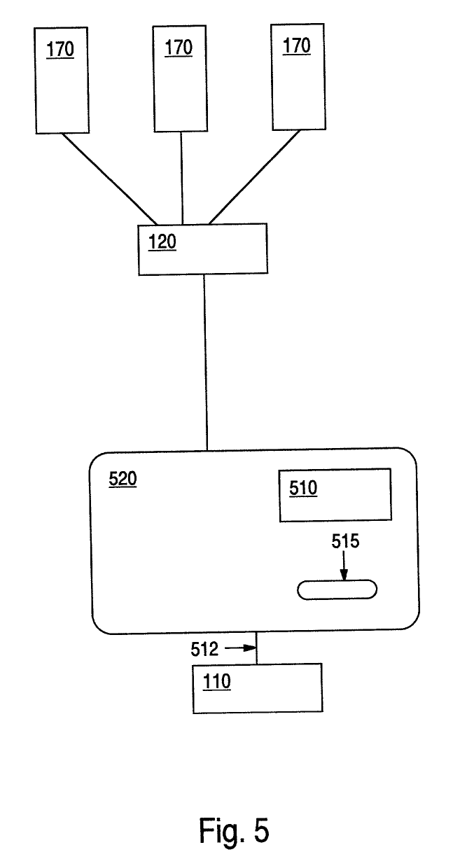

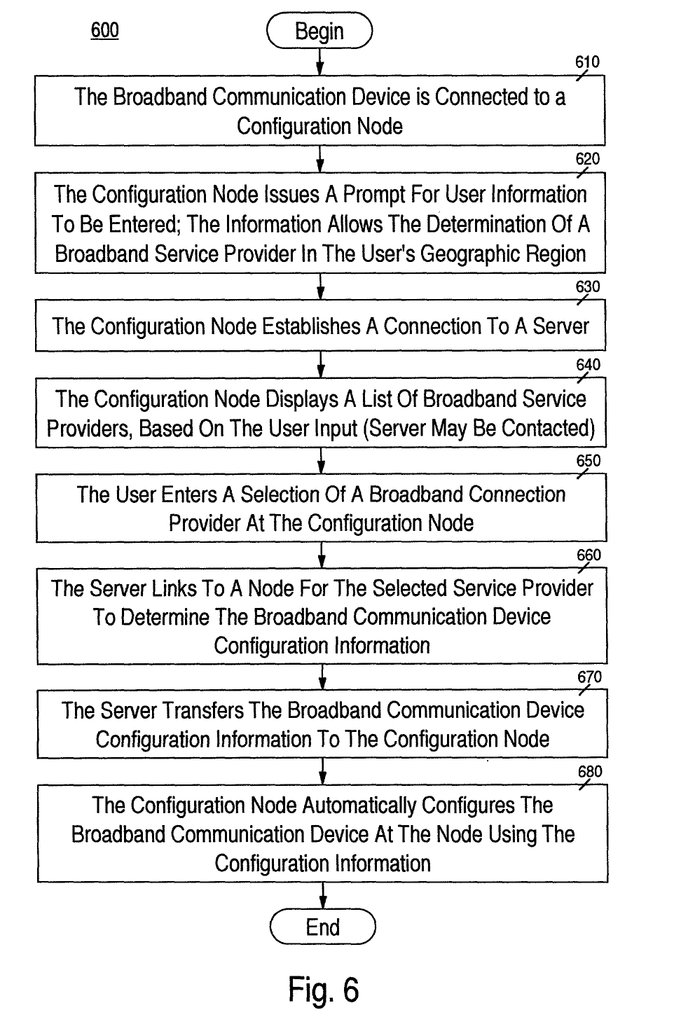

Another embodiment of the present invention provides for a method of provisioning broadband service and automatically configuring a broadband communication device 110 at, for example, a point of purchase. Referring now to the system of FIG. 5 and the process 600 of FIG. 6, this embodiment does not require a dial-up modem 130. The configuration node 520 may be a kiosk used to configure the broadband communication device 110 at the point of purchase, although the configuration may be performed separate from purchase. In step 610, the broadband communication device 110 is connected to the configuration node 520. For example, the consumer may purchase the broadband communication device 110, unpack it from the box, attach it to a power source and local connectivity solution 512 (e.g., Universal Serial Bus, Category 5 Ethernet, serial port, etc.).

In step 620, the configuration node 520 issues a prompt on a display screen 510 for user information to be entered via input device 515. The information allows for the broadband service providers 170 in the user's region to be determined. For example, the user may be prompted for an area code and local telephone number. However, the present invention is not limited to prompting for this information. For example, the user's zip code, address, or other suitable information may be used instead.

In step 630, the configuration node 520 establishes a connection to the central server 120. This connection may be made by any suitable means including, but not limited to, dialing in via a phone line or Internet.

In step 640, the configuration node 520 displays a list of broadband service providers 170, based on the user input.

In step 650, the user selects a broadband service provider 170. This information is transferred to the central server 120, which uses its link to the selected broadband service provider 170 to determine the broadband communication device configuration parameters, in step 660. It will be appreciated that the node 520 may also collect all necessary information to establish broadband access to the selected provider during process 600.

In step 670, the central server 120 transfers the configuration parameters to the configuration node 520.

In step 680, the configuration node 520 uses the parameters to configure the broadband communication device 110. The user may then take the broadband communication device 110 home, connect it to a broadband communication link 161 (e.g., DSL, cable), a power source, and a PC 100. The user may then run an install wizard or the like to configure client PC TCP/IP settings.

The preferred embodiment of the present invention, a method and system for provisioning broadband service and automatically configuring a broadband communication device, is thus described. While the present invention has been described in particular embodiments, it should be appreciated that the present invention should not be construed as limited by such embodiments, but rather construed according to the below claims.

What is claimed is:

1. A method of provisioning broadband service, said method comprising:
a) receiving a request from a node at a remote location;
b) determining broadband service providers for said node, based on said request;
c) transferring a list of said broadband service providers to said node;
d) receiving a selection of a broadband service provider from said node;
e) determining configuration parameters by linking to a node for said selected broadband service provider; and
f) transferring said configuration parameters to said node.

2. The method of claim 1, further comprising:
g) automatically configuring a communication device with said configuration parameters.

3. The method of claim 1, wherein b) comprises:
b1) determining a geographic region of the source of said request; and
b2) determining said list of broadband service providers based on said geographic region.

4. The method of claim 3 wherein b1) comprises determining said geographic region based on a caller-identifier of said request.

5. The method of claim 1, wherein a) comprises receiving said request via a dial-up communication link.

6. The method of claim 1, further comprising g) providing dial-up Internet access for said node; and
wherein f) comprises transferring configuration parameters that allow a plurality of electronic devices coupled to a communication device at said node to share said dial-up Internet access.

7. The method of claim 1, further comprising:
g) brokering a broadband link to said broadband service provider selected in d) for said node.

8. The method of claim 7, wherein f) comprises transferring configuration parameters that allow a plurality of electronic devices coupled to a communication device to share said broadband service.

9. The method of claim 1, further comprising:
g) brokering dial-up Internet access on an interim basis for said node; and
h) switching to said broadband service provider selected in d) for said node.

10. The method of claim 9 wherein f) comprises transferring configuration parameters that allow a plurality of electronic devices coupled to a communication device to share said broadband link.

11. The method of claim 1 wherein b) comprises prompting said node for input to allow determination of said broadband service providers for said node.

12. A system for configuring a communication device, said system comprising:
a server;
a node operable to display a list of broadband service providers and receive a selection of a broadband service provider;
said node further operable to transfer said selection to said server;
said server further operable to provide configuration parameters to said node based on said selection; and
said node further operable to configure said communication device using said configuration parameters.

13. The system of claim 12 wherein said node is further operable to prompt for input to determine said selection of broadband service providers.

14. The system of claim 13 wherein said server is further operable to determine said list of broadband service providers based on said input.

15. The system of claim 12 wherein said server is further operable to broker interim dial-up Internet access.

16. The system of claim 12 wherein said server is further operable to broker broadband service based on said selected broadband service provider.

17. The method of claim 12 wherein said broadband communication device is operable to share a communication link with a plurality of electronic devices, wherein said configuration of said communication device allows sharing of a broadband link provided by said selected broadband service provider.

18. A method of configuring a broadband communication device, said method comprising:
a) issuing a prompt for input at a first node, said input allowing determination of a list of broadband service providers in a user's geographic region;
b) displaying said list of broadband service providers;
c) receiving a selection of a broadband service provider;
d) determining configuration parameters based on said broadband service provider selected in c); and
e) automatically configuring said broadband communication device at said first node using said configuration parameters.

19. The method of claim 18, wherein d) comprises:
d1) establishing a connection between said first node and a server;
d2) said server linking to a node for said service provider selected in c) to determine said configuration parameters; and
d3) said server transferring said configuration parameters to said first node.

20. The method claim 18, further comprising:
f) brokering Internet access service between said service provider selected in c) and a second node for said broadband communication device.

21. The method of claim 18, wherein said input allows determination of a user's geographic location, wherein said list of broadband service providers is determined based on said geographic location.

22. The method of claim 18, wherein said broadband communication device is operable to share a broadband communication link between a plurality of electronic devices; and
wherein e) comprises automatically configuring said broadband communication device to share said broadband communication link.
